(19) United States
(12) Patent Application Publication
(10) Pub. No.: US 2025/0134065 A1
(43) Pub. Date: May 1, 2025

(54) WEARABLE ACCESSORY FOR PETS AND ANIMALS

(71) Applicant: Chieh Wang, New Taipei City (TW)

(72) Inventor: Chieh Wang, New Taipei City (TW)

(21) Appl. No.: 18/434,850

(22) Filed: Feb. 7, 2024

(30) Foreign Application Priority Data
Oct. 27, 2023 (TW) 112141196

(51) Int. Cl. A01K 13/00; A01K 27/00

(52) U.S. Cl. CPC A01K 13/006; A01K 27/001

(57) ABSTRACT

A wearable accessory for a pet or animal includes a hood or head cover. The hood or head cover includes a cover region and a support member. The cover region includes an opening for receiving the pet's or animal's neck. The support member is provided on the cover region for expanding or maintaining the cover region into an expanded configuration. When the hood or head cover is worn on the pet's or animal's neck, a top portion of the cover region is configured to be positioned above the pet's or animal's head to avoid blocking or restricting the pet's or animal's sight or field of view.

### TECHNICAL FIELD

This disclosure relates to accessory and clothing for pets and animals.

### BACKGROUND

The present disclosure is generally related to accessory and clothing worn by pets and animals, and include protective covering from environmental elements, such as rain, wind or sun.

Raincoats or head covers available for pets tend to obstruct or limit the pet's sight, field of view and/or peripheral vision. The portion of the clothing designed to cover or protect the pet's or animal's head may completely and partially block the pet's view and force the pet or animal to only look straight or forward, and/or greatly limit the pet's or animal's peripheral vision. The head cover could also shift or be displaced by pet's or animal's movements or shaking and will require manual adjustment by a human or person. Therefore, it is desirable to provide accessories and clothing for pets and animals that address the aforementioned issues.

### SUMMARY

The present disclosure provides a wearable accessory and clothing for pets and animals that improve or broaden the pets' or animals' sight or field of view. In an embodiment, the wearable accessory or clothing comprises a hood or head cover with a front outer edge and a lateral side edge. In an embodiment, an angle is formed between the front outer edge and the lateral side edge, ranging from about 70 to 210 degrees.

In an embodiment, the hood or head cover comprises a cover region and a support member. An opening is formed in the cover region and is configured to wrap or extend around a portion of a pet's or animal's neck. The cover region has a front outer edge and a lateral side edge. In an embodiment, the lateral side edge is connected to the front outer edge. In another embodiment, the lateral side edge and the front outer edge form a loop or perimeter around the cover region.

In an embodiment, the support member is disposed on the cover region or on a periphery of the cover region. In another embodiment, the support member is made of a flexible material. In another embodiment, the support member is made of a spring steel wire which expands the cover region into a pre-defined or expanded configuration. In another embodiment, when the hood or head cover is worn on the pet's/animal's neck, the front outer edge is above the level or height of the pet's/animal's head. In another embodiment, a gap is provided or formed between the top of the pet's/animal's and the hood or head cover.

In an embodiment, the angle between the front outer edge and the lateral side edge of the hood or head cover is about 70 to 210 degrees. This provides sufficient space or room for the pet/animal to move its head freely and also allow for an unobstructed field of view. In an embodiment, when not in use or for storage, the hood or head cover can be folded or twisted into a compressed form, which enhances portability and minimizes storage space. In another embodiment, the hood or head cover can be worn alone by a pet or animal, such as on the pet's or animal's neck, or the hood or head cover can be connected to or fabricated with a body garment for covering other region of the pet's or animal's body or abdomen region of the pet or animal.

Other objectives, advantages and novel features of the disclosure will become more apparent from the following detailed description when taken in conjunction with the accompanying drawings.

### BRIEF DESCRIPTION OF THE DRAWINGS

FIG. 1A is a perspective view of a wearable accessory in accordance with an embodiment of the present disclosure.

FIG. 1B is an enlarged view of the wearable accessory of FIG. 1A.

FIG. 2 is another perspective view of the wearable accessory of FIG. 1A.

FIG. 3A is a front view of the wearable accessory of FIG. 1A.

FIG. 3B is an enlarged view of the wearable accessory of FIG. 4A.

FIG. 4A is a side view of the wearable accessory of FIG. 1A.

FIG. 4B is an enlarged view of the wearable accessory of FIG. 4A.

FIG. 5 is a top view of the wearable accessory of FIG. 1A.

FIG. 6 is a bottom view of the wearable accessory of FIG. 1A.

FIG. 7 is a schematic view of the wearable accessory of FIG. 1A, shown in a compressed or folded state.

FIG. 8 is a schematic view of the wearable accessory of another embodiment of the present disclosure.

FIG. 9 is a perspective view of a cover region of the wearable accessory of another embodiment of the present disclosure.

FIG. 10 is a partial cross-sectional view of the wearable accessory of FIG. 1.

FIG. 11 is a side view of the wearable accessory of another embodiment of the present disclosure.

FIG. 12 is a bottom view of the wearable accessory of FIG. 11.

FIG. 13 is a perspective view of the wearable accessory of FIG. 11.

### DETAILED DESCRIPTION

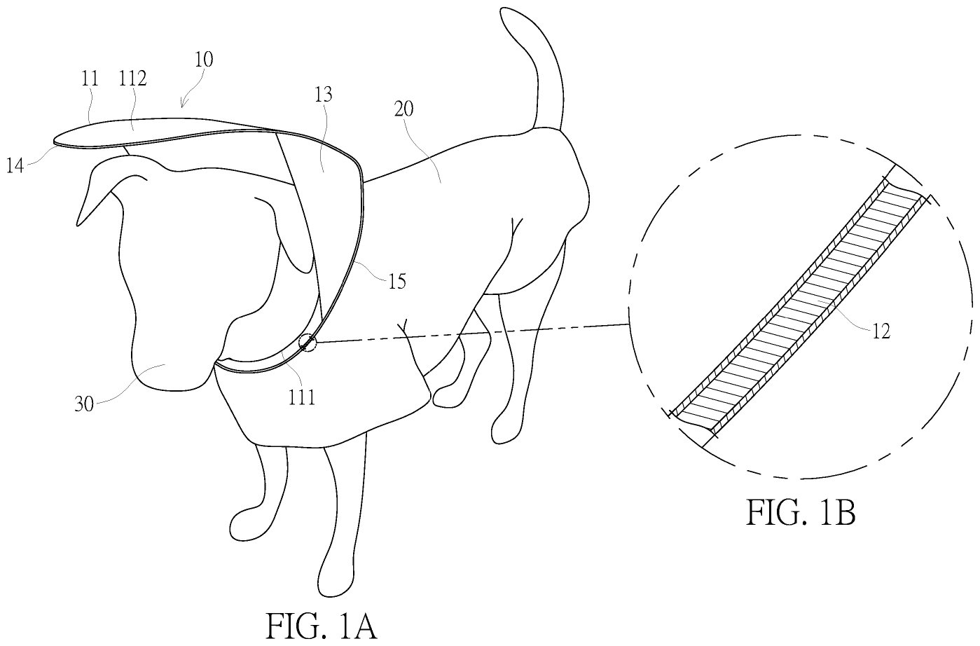

With reference to FIG. 1A, a wearable accessory of an embodiment of the present disclosure is configured to be worn on a neck of a pet 30 or animal and covers a pet's 30 or animal's head region. In an embodiment, the wearable accessory comprises a hood 10 or head cover. In another embodiment, the hood or head cover is attached to or fabricated with a body garment 20.

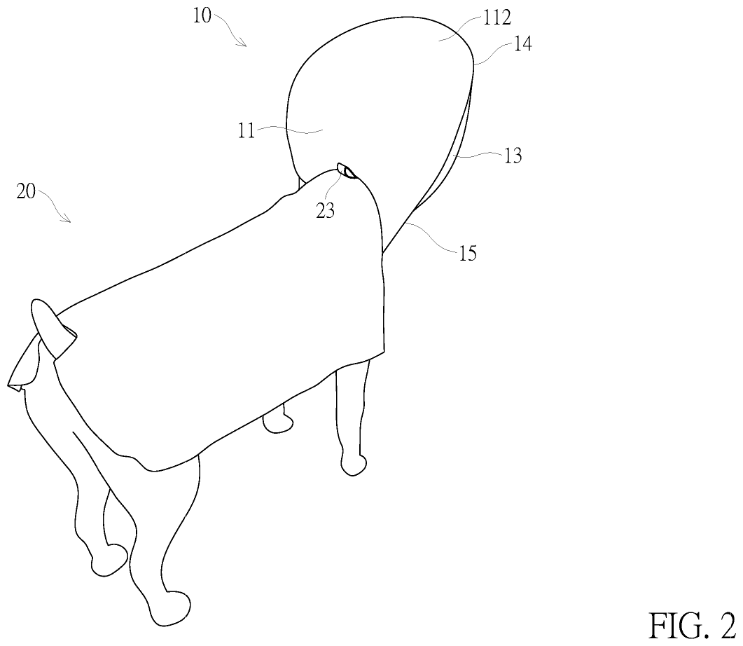

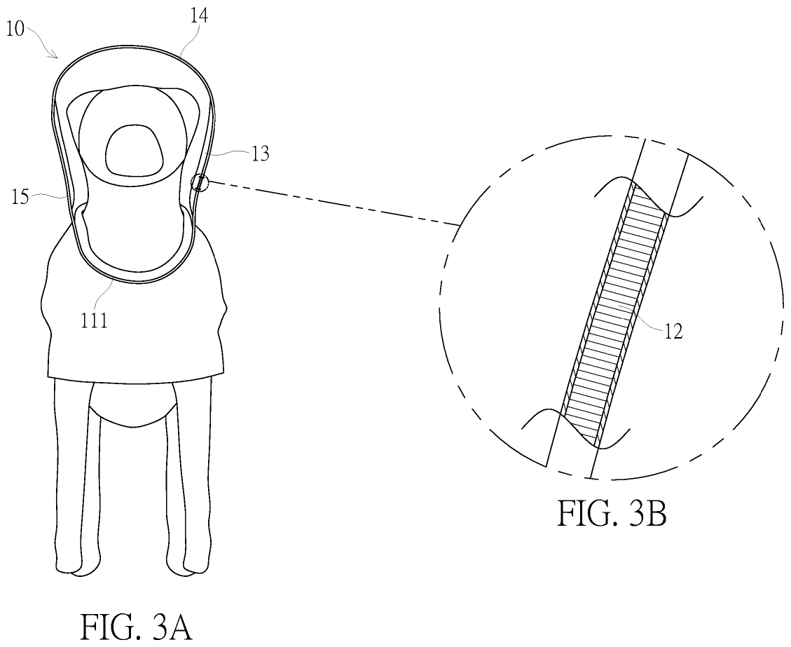

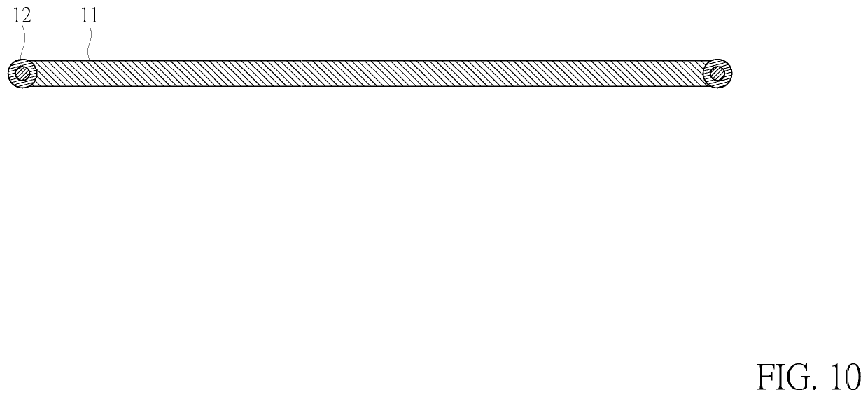

With reference to FIGS. 1A to 3B, and FIG. 10, the hood 10 or head cover has a cover region 11, a support member 12, and two adjustment members 13. In an embodiment, the cover region 11 is made of a soft material, such as a waterproof fabric, or fabric or material which blocks or reflects sunlight or UV radiation. The materials suitable for fabricating the hood or cover region are not limited to these examples. In an embodiment, the hood or cover region can be made by sewing, 3D printing, molding, stamping or other manufacturing techniques. In an embodiment, the cover region 11 includes an opening 111. The opening 111 is configured to extend or wrap around a portion of the neck of the pet 30 or animal. The cover region 11 includes a top portion 112. In an embodiment, when the hood 10 or head cover is in use or worn by the pet 30 or animal, the top portion 112 is above the level or height of the head of the pet 30 or animal. In another embodiments, the support member 12 may be provided on the cover region 11, or mounted or disposed on a periphery of the cover region 11. In another embodiments, the support member 12 is provided on a periphery of the cover region 11, and forms a closed or semi-closed loop structure. In another embodiment, the support member 12 forms a loop around the outer perimeter of the cover region 11. In other embodiments, a portion of the support member 12 extends below or under the neck of the pet 30 or animal. The support member 12 can be fabricated of a flexible rod or wire that can be bent by external force and is restorable to its original shape when the external force is removed, such as memory alloy, nickel-titanium alloy, carbon fiber composite material, spring steel wire, spring steel flat wire, etc. The materials suitable for the support member 12 are not limited to these examples. In an embodiment, the support member 12 is mounted on the cover region 11 or attached to a periphery of the cover region 11, such as by sewing, gluing or other suitable fastening techniques, and expands the cover region 11 into an expanded form. In an embodiment, a sleeve or conduit is formed on a periphery of the cover region for receiving and/or retaining the support member 12. In an embodiment, the cover region 11 opens or expands to its expanded form/configuration. In an embodiment, the front outer edge 14 is connected to the lateral side edge 15. In an embodiment, the opening 111 is adjacent to or in proximity to the lateral side edge 15. In other embodiments, a portion of the support member 12 extends to a lower position relative to the pet's/animal's neck or head. In other embodiments, the cover region 11 can be made of rigid or semi-rigid materials, such as plastic or polymeric materials.

With reference to FIGS. 1A, 2, and 4A, the adjustment member 13 is connected to the front outer edge 14 and the lateral side edge 15 of the cover region 11. In an embodiment, the adjustment member 13 can be attached to the front outer edge 14 and the lateral side edge 15 by sewing or other suitable fastening technique, thereby shaping the covering region 11 and forming an angle A between the front outer edge 14 and the lateral side edge 15. In an embodiment, angle A preferably ranges from 70 to 210 degrees. In an embodiment, an extension line L1 of the front outer edge 14 intersects an extension line L2 of the lateral side edge 15 to form angle A. In other embodiments, angle A between the front outer edge 14 and the lateral side edge 15 can be adjusted as needed. In other embodiments, the adjustment member 13 is made of a flexible or rigid material. In other embodiments, flexible member 13 is a rope, metal wire, or cloth or fabric that does not block the view on the left and right sides of the pet 30 or animal. In other embodiments, when the hood 10 or head cover is worn by the pet 30 or animal, such as on the neck of the pet 30 or animal, the front outer edge 14 of the cover region 11 is positioned or elevated above the head of the pet 30 or animal while the pet/animal is facing in the forward direction. In other embodiments, the front outer edge 14 or the top portion 112 of the hood 10 or head cover is elevated above the head of the pet 30 or animal, and the hood 10 or head cover has a L-shaped or substantially L-shaped configuration when viewed from the side.

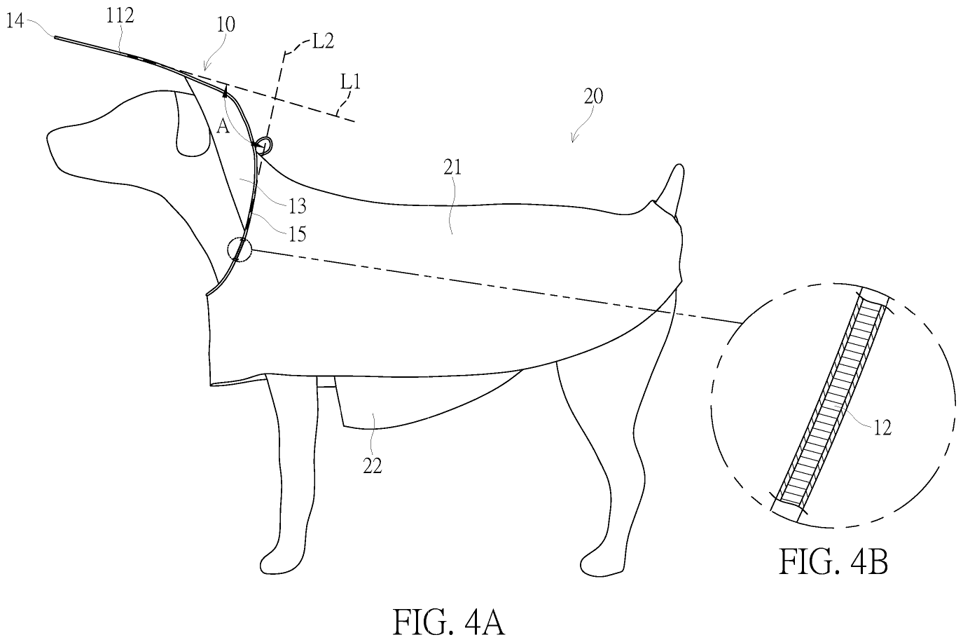

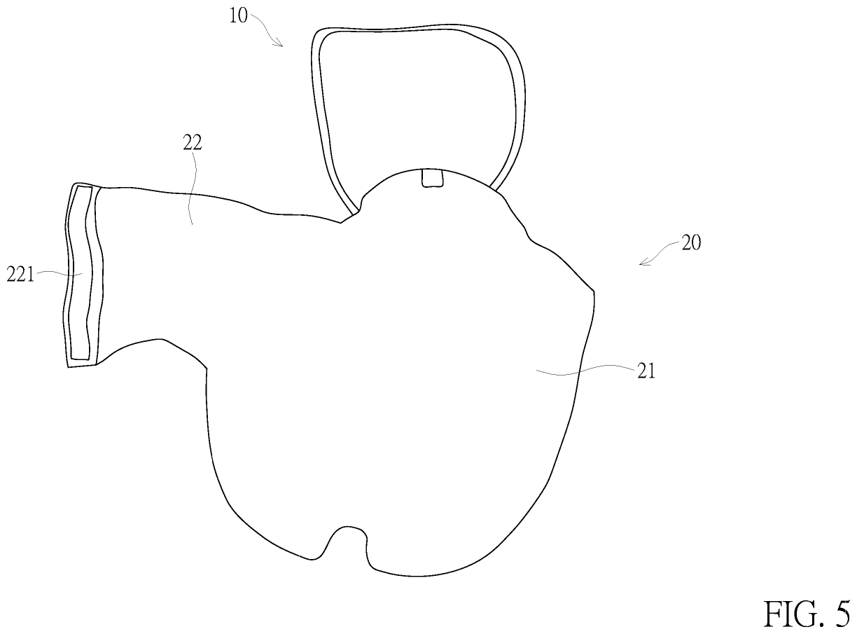

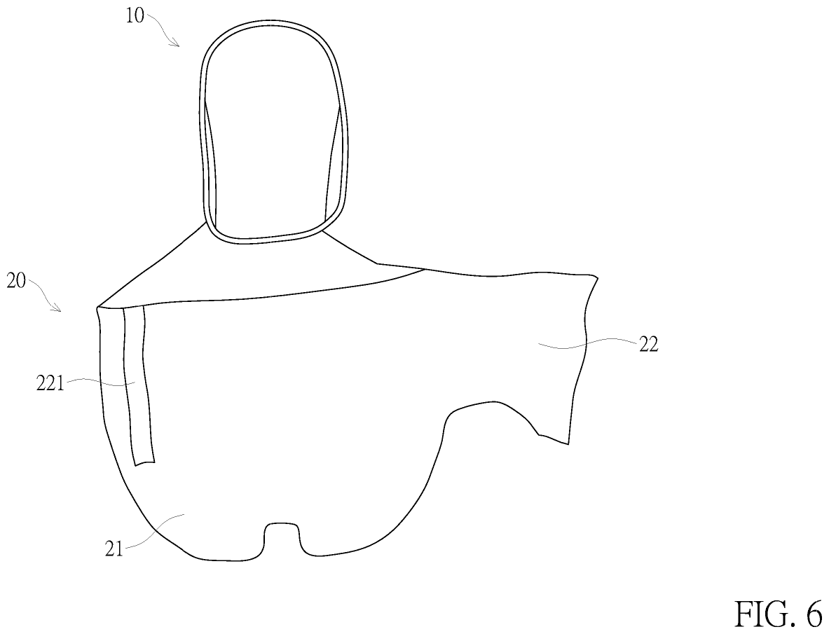

With reference to FIGS. 4A to 6, in an embodiment, the body garment 20 is fabricated of a single sheet of material. In an embodiment, one end of the body garment 20 is connected to or provided with the hood 10 or head cover. In another embodiment, the body garment 20 is connected to a portion of the hood 10 or head cover adjacent or in proximity to the opening 111. In another embodiment, the body garment 20 is shaped or configured to match the body contour or length of the pet 30 or animal. In another embodiment, the body garment 20 has an enveloping section 21 and a connecting section 22. The connecting section 22 extends outwards from one side of the enveloping section 21 and is configured to extend around the pet's/animal's abdomen and fastened to the other side of the enveloping section 21. In an embodiment, a connecting member 221 is provided on the connecting section 22 for securing or connecting the connecting section 22 and the enveloping section 21. In another embodiment, the connecting member 221 can be a hook-and-loop fastener, zipper, magnet, button, etc., and the corresponding fastening elements can be provided on the side of the enveloping section 21 opposite the connecting section 22 to secure the body garment 20 to the body or abdomen area of the pet 30 or animal. In another embodiment, the body garment 20 includes a fastening member 23 mounted on a side of the body garment 20 adjacent or in proximity to the hood 10 or head cover. In another embodiment, the fastening member 23 is a ring or loop and is configured for attaching a leash or other articles such as battery powered light or carabiner clip. The configuration of the body garment 20 can be adjusted as needed.

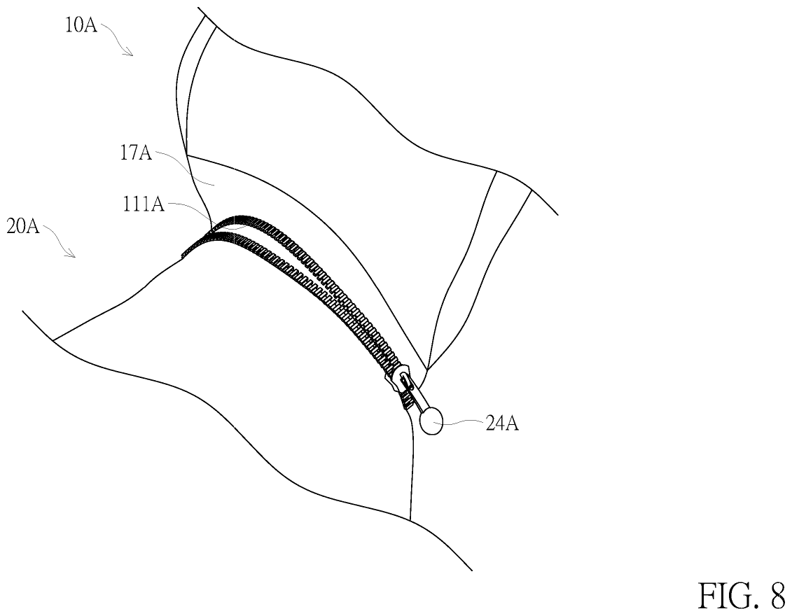

With reference the embodiment of FIG. 8, the hood 10A or head cover and the body garment 20A are detachable from each other. In another embodiment, a joining member 24A, such as a zipper or other fastening or connecting mechanisms, is provided to releasably connect the hood 10A or head cover and the body garment 20A. In another embodiment, the joining member 24A can be a hook-and-loop fastener, zipper, magnet, button, etc., for forming a releasable connection between the hood 10A or head cover and the body garment 20A. In another embodiment, the hood 10A or head cover can be worn alone or with the body garment 20A. In an embodiment, a sleeve region 17A can be provided around the opening 111A. In another embodiment, the sleeve region 17A forms a loop or skirt around the opening and extends around and covers a length of the pet's/animal's neck. In an embodiment, the sleeve region 17A is configured to enhance the stability of the hood 10 or head cover when worn on and extends or covers a length of the neck of the pet 30 or animal. In another embodiment, the sleeve region 17A can additionally be secured to the pet's/animal's neck with a belt, rope or collar. In another embodiment, the sleeve region 17A is optional.

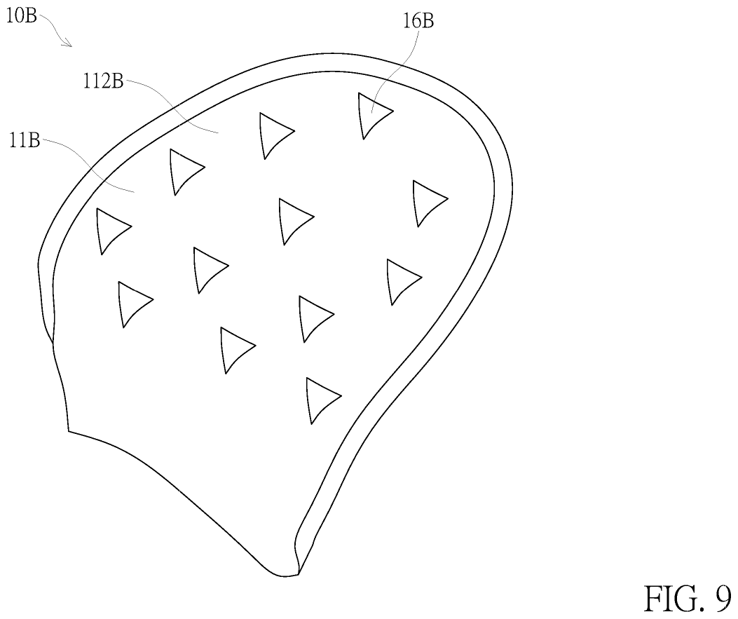

With reference to the embodiment of FIG. 9, the top portion 112B of the cover region 11B includes one or more vent structure(s) 16B or cut-out(s). In another embodiment, slit(s) or incision(s) is provided on the cover region 11B to reduce wind resistance. In an embodiment, several vent structures 16B are formed and spaced apart on the top portion 112B of the cover region 11B. In another embodiment, the vent structure(s) 16B can be formed as a linear shape or as perforation(s). The vent structure(s) 16B allows airflow through the cover region 11B to prevent the cover region 11B from being lifted or forced upward or from bending backward by the wind.

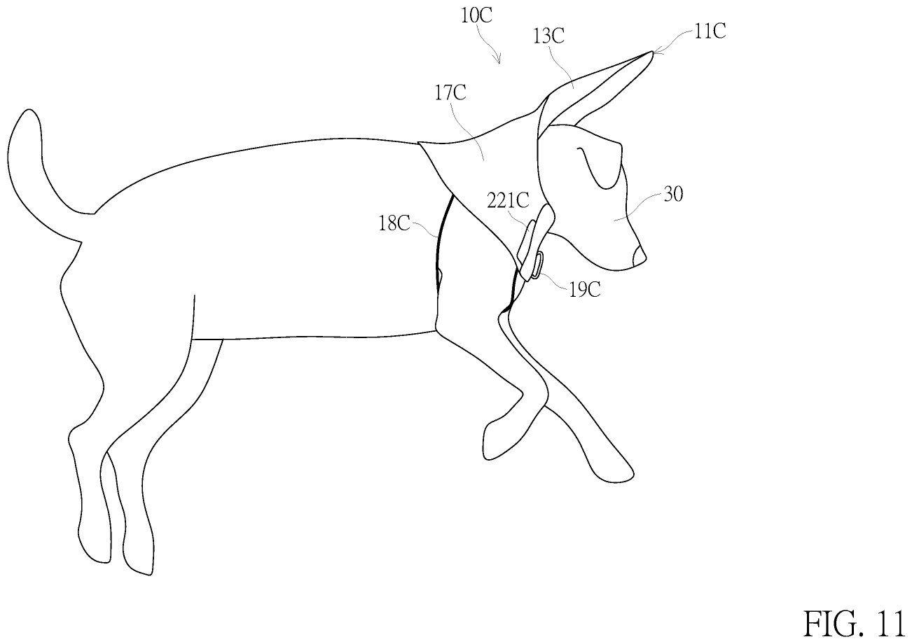

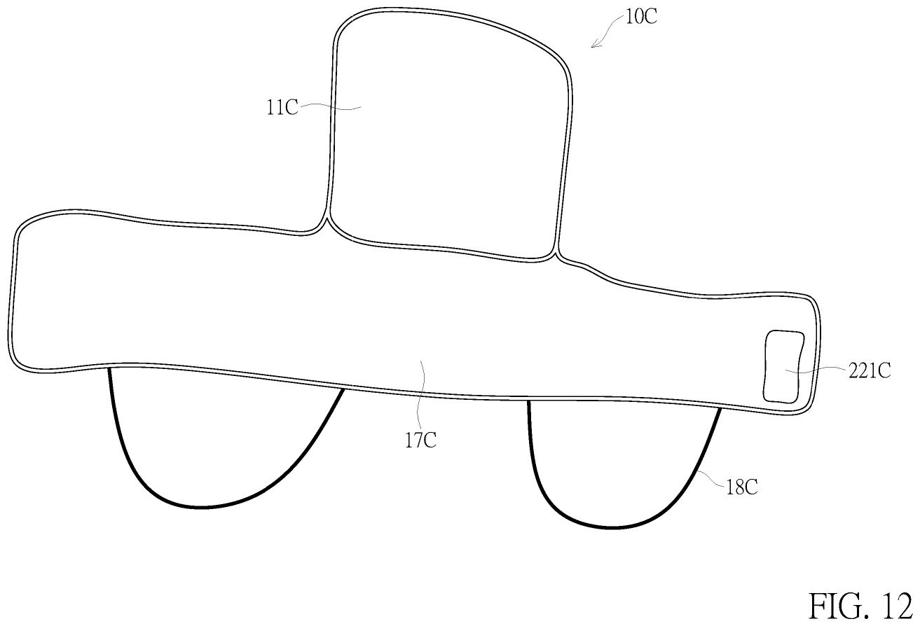

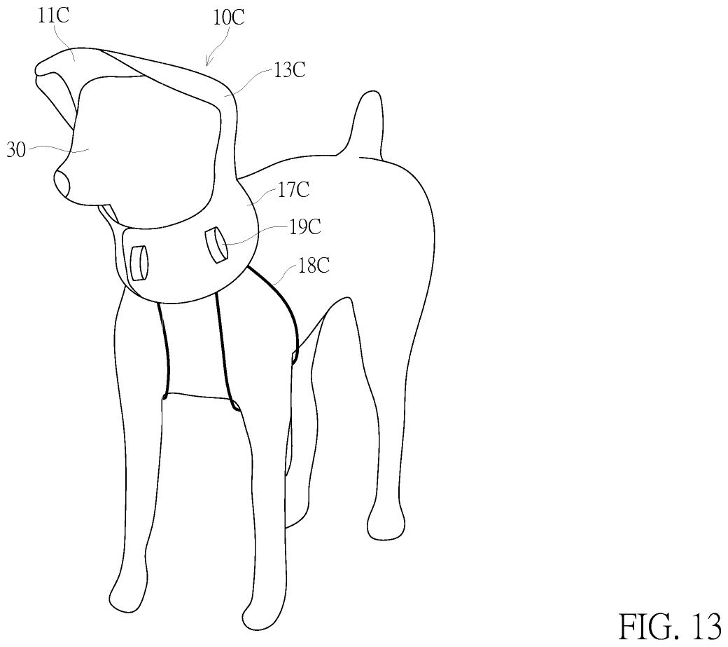

With reference to the embodiment of FIGS. 11 to 13, the hood 10C or head cover can be worn alone by the pet 30 or animal. In an embodiment, the hood 10C or head cover has a cover region 11C, a support member, and an adjustment member 13C. In other embodiments, the sleeve region 17C is formed of an elastic sheet of fabric or material. In another embodiment, the sleeve region 17C has a tubular body or structure. In an embodiment, the sleeve region 17C comprises two ends with a connecting member 221C provided at each end for joining the two ends to each other. In other embodiments, the sleeve region 17C is made by integrated molding. In other embodiments, a securing or stabilizing element 18C, such as a strap, sleeve or elastic cord, is attached to a lower edge or portion of the sleeve region 17C or to the hood 10C or head cover. In other embodiments, the hood 10C or head cover or cover region comprises a pair of securing or stabilizing element 18C, such as elastic cords, loops, sleeves or rings, for securing the hood 10C or head cover or sleeve region 17C to the front legs of the pet/animal. In another embodiment, the securing or stabilizing element is a fabric or sleeve with opening suitable for receiving the leg of the pet/animal. In other embodiments, a plurality of loop members 19C is mounted at an outer surface of the sleeve region 17C. In other embodiments, the position of the securing or stabilizing element 18C corresponds to the leg of the pet 30 or animal. In other embodiments, the securing or stabilizing element 18C extends under or below the front armpits of a four-legged pet or animal. In other embodiments, the loop members 19C are spaced apart. In other embodiments, when the wearable accessory is worn on the neck of the pet 30 or animal, a person can position the sleeve region 17C around the neck of the pet 30 or animal and connect the two connecting members 221C to close or secure the ends of the sleeve region 17C. The connecting members 221 are optional. The sleeve region 17C can be formed into a tubular structure without the connecting members 221. In another embodiment, elastic cords are respectively worn on, attached to or looped over the legs of the pet 30 or animal to enable the hood 10C to be more stably or securely worn or retained on the neck of the pet 30 or animal. In another embodiment, a collar can be passed through the loop members 19C and fasten to the sleeve region 17C.

With reference to FIGS. 1, 3, and 4, to put on the wearable accessory on the pet 30 or animal, first, the head of the pet 30 or animal is first passed through the opening 111. The body garment 20 can be transformed to an expanded state to envelop or cover the body of the pet 30. The body garment 20 can be fastened by using the connecting member 221, which enables the wearable accessory to be rapidly worn or removed. The wearable accessory can protect the pet 30 or animal from rain, sun, cold weather, etc., depending on materials used for the cover region 11. In an embodiment, an adequate angle is maintained or provided between the front outer edge 14 and the lateral side edge 15 of the cover region 11, such that the pet 30 or animal can freely move its head without its vision or field of view being blocked or restricted by the hood 10 or head cover.

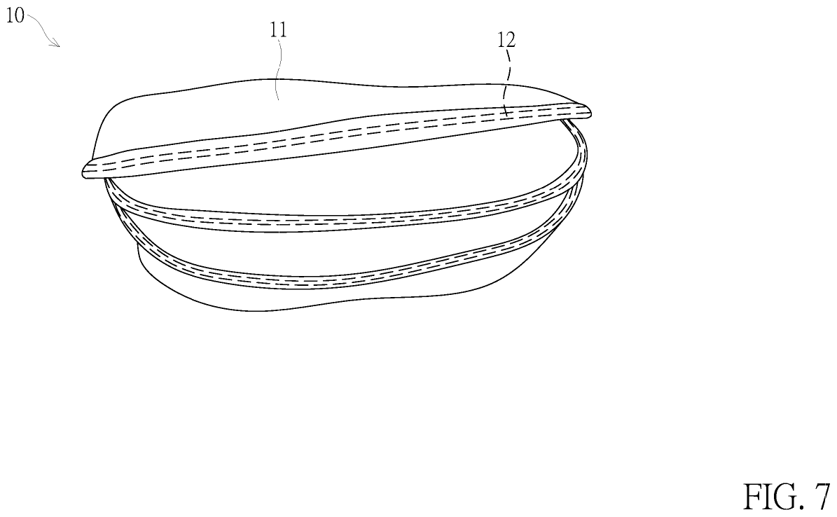

With reference to the embodiment of FIG. 7, the hood 10 or can be compressed into two or three overlapping loops or portions. In an embodiment, the body garment 20 (if present or provided) can be folded or tucked into the spaces formed by the overlapping loops or portions. In another embodiment, a retaining assembly, such as a Velcro, magnet, pouch etc., is used to retain the hood 10 or head cover in its compressed or folded configuration to reduce the storage space, but the retaining assembly is not limited to the foregoing technique or assembly. The storage method can be changed as needed, making the hood 10 highly convenient and portable. In other embodiments, to use the hood 10 or head cover, the user releases the retaining assembly and allows the hood 10 or head cover to expand to a ready-to-use state or expanded configuration, such as the configuration shown in FIG. 1A. In other embodiments, the cover region 11 is switchable or adjustable between a compressed state and an expanded state. In other embodiments, in the compressed state, the cover region 11 is self-overlapping, reducing its overall volume and/or area. In the expanded state, the support member 12 expands the hood 10 or head cover to its uncompressed state.

What is claimed is:

1. A wearable accessory for a pet, comprising:
a cover region;
an opening formed in the cover region and configured to receive and extend around a portion of the pet's neck region;
a top portion of the cover region configured to be positioned above the pet's head region; and
a support member provided on the cover region for flexibly expanding the cover region into an expanded configuration,
wherein the support member forms a loop and a portion of the support member extend under a portion of the opening or under the pet's neck region.

2. The wearable accessory of claim 1, further comprising adjustment members provided on each side of the cover region.

3. The wearable accessory of claim 1, wherein the support member is disposed on a periphery of the cover region.

4. The wearable accessory of claim 1, wherein the cover region has a L-shaped or convex configuration.

5. The wearable accessory of claim 1, wherein in the expanded configuration, the cover region comprises a first portion and a second portion.

6. The wearable accessory of claim 5, wherein the first and second portions form an obtuse angle.

7. The wearable accessory of claim 5, wherein the first portion comprises the top portion of the cover region, and the second portion comprises the opening.

8. The wearable accessory of claim 5, wherein the first and second portions form an angle from 70 to 210 degrees.

9. The wearable accessory of claim 8, further comprising adjustment members provided on each side of the cover member, wherein the adjustment member is configured to limit the angle between the first and second portions to a predefined angle.

10. The wearable accessory of claim 1, wherein the support member is a flat metal wire.

11. The wearable accessory of claim 1, further comprising one or more air venting structure.

12. The wearable accessory of claim 1, further comprising a plurality of air venting structures spaced apart from each other.

13. The wearable accessory of claim 7, further comprising a body garment extending from the second portion of cover region.

14. The wearable accessory of claim 7, further comprising a body garment connected to a portion of the opening.

15. The wearable accessory of claim 13, wherein the body garment is releasably attached to the cover region.

16. The wearable accessory of claim 1, further comprising a sleeve disposed on the second portion of the cover region, and configured to cover a length of the pet's neck region.

17. The wearable accessory of claim 7, further comprising a pair of loops or sleeves, wherein each loop or sleeve is configured to receive the pet's front leg to provide stability or maintain the top portion of the cover region above the pet's head region.

18. The wearable accessory of claim 1, wherein the support member automatically expands to cover region to the expanded configuration when released from a compressed or folded state.

19. The wearable accessory of claim 1, wherein the cover region comprises a compressed state, wherein in the compressed state, the cover region is releasably folded or arranged into a flat configuration or shape.

20. The wearable accessory of claim 19, wherein in the compressed stated, the cover region is releasably folded into an overlapping structure.
